(19) United States
(12) Patent Application Publication
(10) Pub. No.: US 2013/0062978 A1
(43) Pub. Date: Mar. 14, 2013

(54) ELECTRIC ROTATING MACHINE

(71) Applicants: Masato YAMAJI, Anjo-shi (JP); Hiroyuki IKUTA, Anjo-shi (JP)

(72) Inventors: Masato YAMAJI, Anjo-shi (JP); Hiroyuki IKUTA, Anjo-shi (JP)

(73) Assignee: DENSO CORPORATION, Kariya-city (JP)

(21) Appl. No.: 13/612,987

(22) Filed: Sep. 13, 2012

(30) Foreign Application Priority Data
Sep. 14, 2011 (JP) 2011-200243

(51) Int. Cl. H02K 3/28

(52) U.S. Cl. 310/71

(57) ABSTRACT

The electric rotating machine includes a cooling means for supplying liquid coolant to the stator winding. The stator winding includes a plurality of conductor segments each having a pair of in-slot portions, a turn portion connecting the in-slot portions and skew portions respectively extending from the in-slot portions. Joint portions where distal end portions of respective corresponding two of the skew portions are joined to each other are formed on one axial end side of the stator core. The joint portions are disposed at a substantially constant pitch and in multiple circular rings. The joint portions are also disposed in a plurality of rows in the axial direction, each row of the joint portions being covered and bridged together by an insulating resin member. A gap is provided between each circumferentially adjacent two of the rows of the joint portions.

This application claims priority to Japanese Patent Application No. 2011-200243 filed on Sep. 14, 2011, the entire contents of which are hereby incorporated by reference.

### BACKGROUND OF THE INVENTION

1. Field of the Invention

The present invention relates to an electric rotating machine which can be mounted on a vehicle to be used as a motor or an alternator.

2. Description of Related Art

Generally, an electric rotating machine mounted on a vehicle to be used as a motor or an alternator includes a rotor and a stator having a stator core disposed facing the rotor and a stator winding wound on the stator core. Each of Japanese Patent Application Laid-open Nos. 2001-204151 (patent document 1) and 2000-060051 (patent document 2) discloses an electric rotating machine of the segment type where the stator winding is made up of a plurality of conductor segments including in-slot portions accommodated in slots formed in the stator core and coil end portions exposed from the slots in the axial direction and extending in the circumferential direction of the stator core. Each of patent documents 1 and 2 also discloses cooling the stator, which generates a large amount of heat, using a cooling fan.

Patent document 1 discloses also radially bridging insulating resin members covering the weld portions (joint portions) of the conductor segments arranged in multiple circular rings, and circumferentially bridging them unevenly. This makes it possible to reduce the drag of the cooling air to thereby reduce the periodic noise because the drag of the cooling air becomes uneven in the circumferential direction.

Patent document 2 discloses also circularly bridging insulating resin members covering the weld portions arranged in a circular ring in order to reduce vibration and noise.

Generally, high-output electric motors employ a liquid-cooling structure where liquid coolant is directly dropped onto the stator winding instead of an air-cooling structure as disclosed in patent document 1 or 2. In such a liquid-cooling structure, the dropped liquid coolant flows on the surface of the stator winding in the radial direction and takes heat from the stator to cool the stator. In this structure, an important thing is that the liquid coolant flows smoothly in the radial direction. However, if the insulating resin members are bridged in the circumferential direction, the liquid flow is prevented from flowing by these insulating resin members.

In the case of a high-voltage and high-output electric rotating machine, heat generated by the stator is considerably large. Particularly, the temperature of the stator becomes very high at the coil-concentrated area in the coil end portions where the skew portions of the conductor segments intersect each other. Accordingly, breakages or cracks may occur in the insulating members covering this coil-concentrated area by repetitive coil deformation due to large temperature change. If the breakages or cracks develop, the inner conductor of the stator winding may be exposed.

Further, in a case where thermosetting powder resin is employed as the material of the insulating resin member, since air entrainment occurs when the powder resin is adhered, voids are easily created in the adhered resin. Accordingly, if the voids are connected to form a large void extending through between different conductor segments, the inter-coil creepage distance is shortened. If this phenomenon occurs between any two of the different phase coils, electric discharge may occur between them.

### SUMMARY

An exemplary embodiment provides an electric rotating machine comprising:

a rotor;

a stator including a stator core disposed facing the rotor and a stator winding wound around the stator core; and

a cooling means for supplying liquid coolant to the stator winding to cool the stator winding,

wherein

the stator winding includes a plurality of conductor segments each having a first in-slot portion accommodated in a first one of slots formed in the stator core and a second in-slot portion accommodated in a second one of the slots, and first and second coil end portions respectively projecting from the first and second ones of the slots in an axial direction of the stator core and extending in a circumferential direction of the stator core,

the first coil end portion includes a turn portion connecting the first and second in-slot portions on a first axial end side of the stator core,

the second coil end portion includes a skew portion intersecting with a skew portion of another one of the conductor segments on a second axial end side of the stator core,

a plurality of joint portions where distal end portions of respective corresponding two of the skew portions are joined to each other are formed on the second axial end side of the stator core, the joint portions have a substantially same axial height and being disposed at a substantially constant pitch and in multiple circular rings,

the joint portions are disposed in a plurality of rows in the axial direction, each row of the joint portions being covered and bridged together by an insulating resin member, and

a gap is provided between each circumferentially adjacent two of the rows of the joint portions.

According to the exemplary embodiment, there is provided a high-voltage and high-output electric rotating machine having a high cooling performance and a high insulating performance.

Other advantages and features of the invention will become apparent from the following description including the drawings and claims.

### BRIEF DESCRIPTION OF THE DRAWINGS

In the accompanying drawings:

FIG. 1 is an axial cross-sectional view of an electric rotating machine according to an embodiment of the invention;

FIG. 2 is an entire perspective view of a stator of the electric rotating machine according to the embodiment;

FIG. 3 is a partial perspective view of the stator of the electric rotating machine according to the embodiment;

FIG. 4 is a partial perspective view of the stator of the electric rotating machine according to the embodiment;

FIG. 5 is a partial side view of the stator of the electric rotating machine according to the embodiment;

FIG. 6 is a partial cross-sectional view showing a joint area between adjacent conductor segments and its vicinity of the stator of the electric rotating machine according to the embodiment;

FIG. 7 is an explanatory view showing how the conductor segments are inserted into the slots of the stator core of the stator of the electric rotating machine according to the embodiment; and

FIG. 8 is an entire perspective view of a stator of a modification of the electric rotating machine according to the embodiment.

### PREFERRED EMBODIMENTS OF THE INVENTION

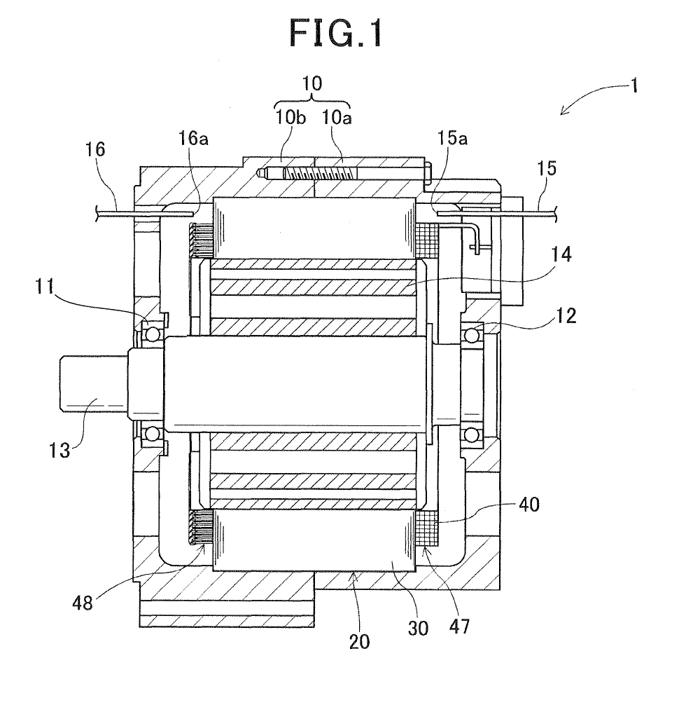

FIG. 1 is an axial cross-sectional view of an electric rotating machine 1 according to an embodiment of the invention. The electric rotating machine 1 is mounted on a vehicle to be used as a vehicle-use motor. As shown in FIG. 1, the electric rotating machine 1 includes a housing 10, a rotor 14 and a stator 20. The housing 10 is constituted of a pair of housing members 10a and 10b joined to each other at their opening portions. The rotor 14 is rotatably supported by the housing 10 through bearings 11 and 12. The stator 20 is fixed to the housing 10 so as to surround the rotor 14 within the housing 10.

The electric rotating machine 1 further includes a coolant supply means including a pair of pipelines 15 and 16 for supplying liquid coolant to a stator winding 40 of the stator 20. The pipelines 15 and 16 are mounted on the housing members 10a and 10b so as to penetrate through the housing members 10a and 10b, respectively. The pipeline 15 is formed with a discharge hole 15a. The pipeline 16 is formed with a discharge hole 16a. The discharge hole 15a opens at a position vertically upward of a first coil end group 47 of the stator winding 40 of the stator 20 housed in the housing 10. The discharge hole 16a opens at a position vertically upward of a second coil end group 48 of the stator winding 40 of the stator 20 housed in the housing 10.

The electric rotating machine 1 is provided with, in the circulation path of the liquid coolant, a recovery means (not shown) for recovering the liquid coolant discharged from the discharge holes 15a and 16a and returning it to the coolant supply means, and a cooler (not shown) for cooling the liquid coolant having been heated. These components constitute a cooling device for cooling the stator winding 40 of the stator 20. ATF (Automatic Transmission Fluid) is used as the liquid coolant in this embodiment. However, any type of coolant liquid used for conventional electric rotating machines may be used.

The rotor 14 includes a plurality of evenly spaced permanent magnets which are disposed on the outer periphery thereof facing the inner periphery of the stator 20. These permanent magnets constitute a plurality of magnetic N and S poles which alternate along the circumferential direction. The number of the magnetic poles depends on the specification of the electric rotating machine 1. In this embodiment, the rotor 14 is an eight-pole rotor having four N poles and four S poles.

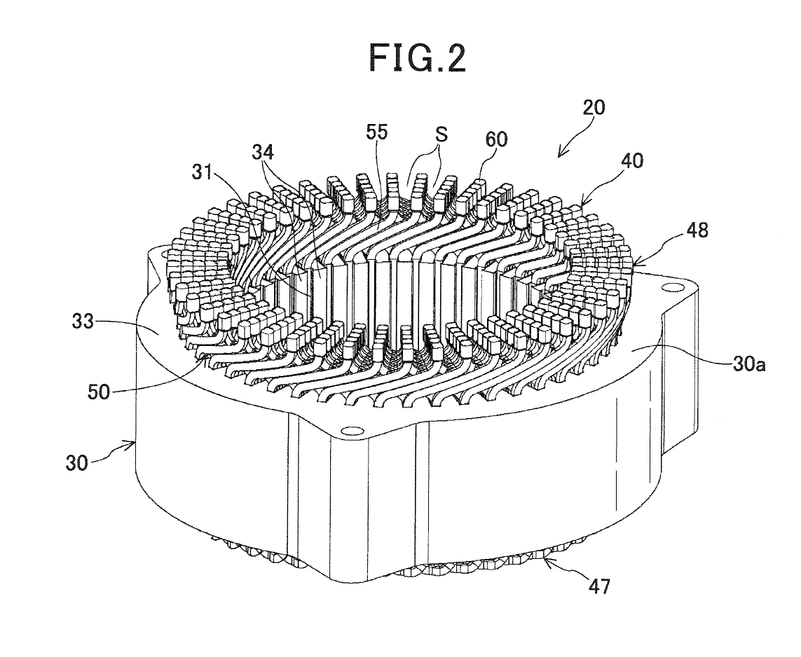

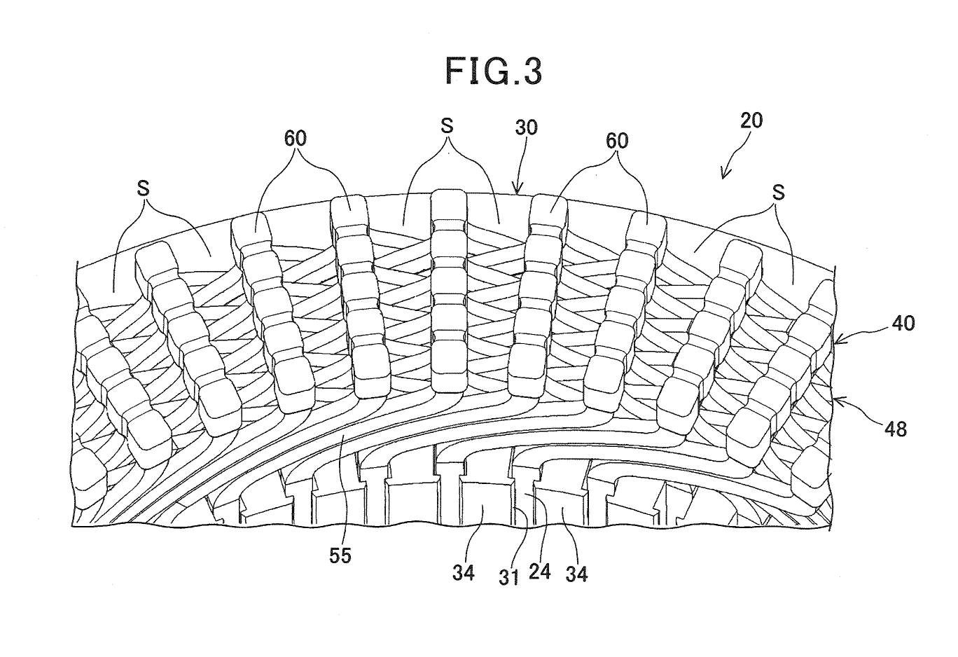

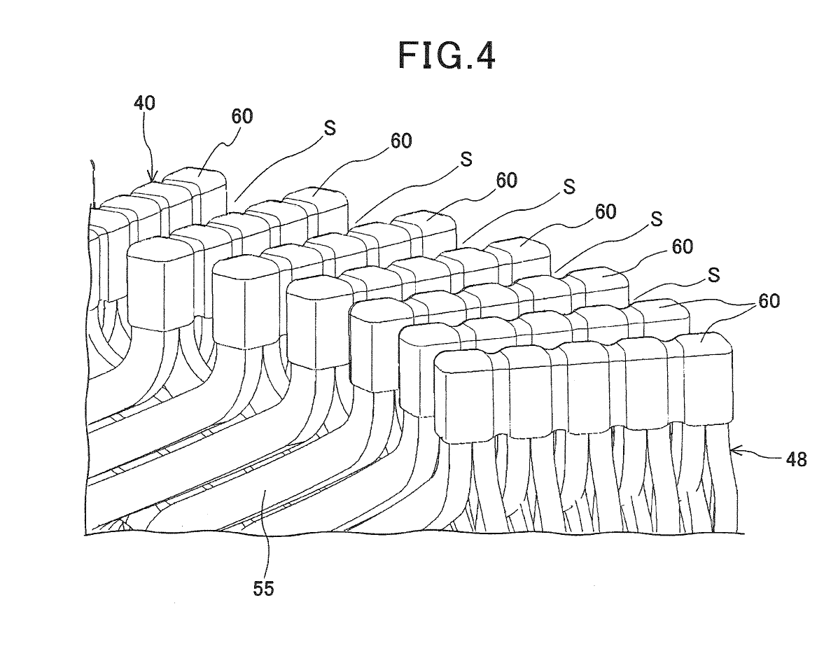

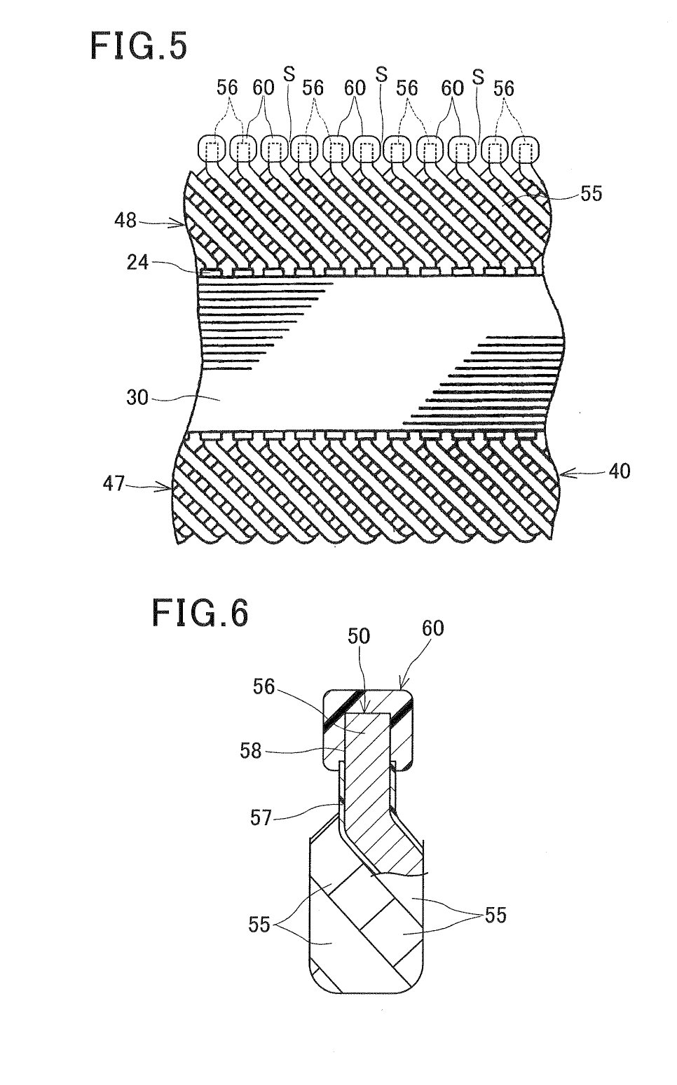

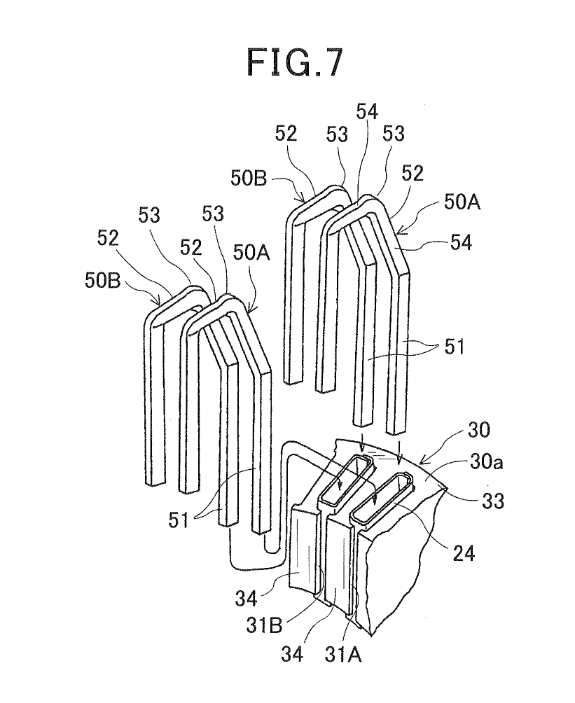

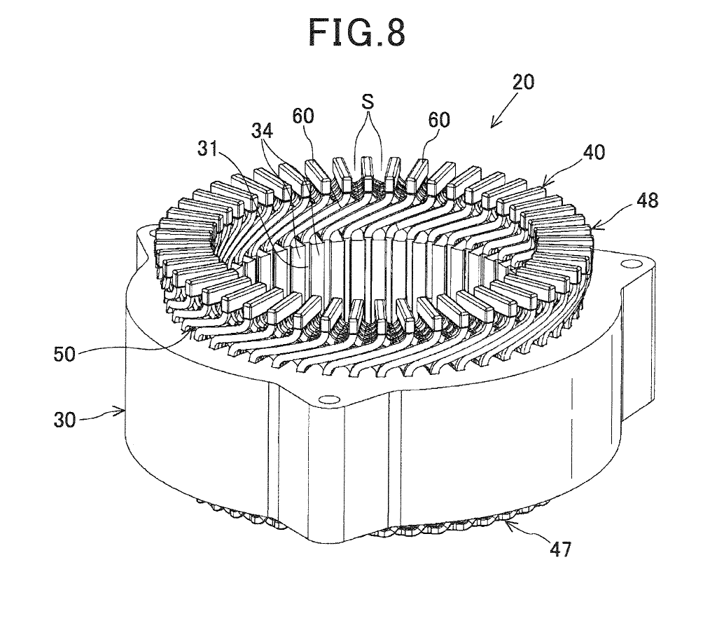

Next, the stator 20 is explained with reference to FIGS. 2 to 7. FIG. 2 is an entire perspective view of the stator of the electric rotating machine 1. FIG. 3 is a partial perspective view of the stator of the electric rotating machine 1. FIG. 4 is a partial perspective view of the stator of the electric rotating machine 1. FIG. 5 is a partial side view of the stator of the electric rotating machine 1. FIG. 6 is a partial cross-sectional view showing a joint area between adjacent conductor segments and its vicinity of the stator of the electric rotating machine 1. FIG. 7 is an explanatory view showing how the conductor segments are inserted into the slots of the stator core of the stator of the electric rotating machine 1.

As shown in FIG. 2, the stator 20 includes a stator core 30 having a ring shape, and a three-phase stator winding 40 constituted of a plurality of U-shaped conductor segments 50. The stator core 30 is formed with a plurality of slots 31 disposed along the circumferential direction. The stator winding 40 is wound on the stator core 30 such that one end portions of each corresponding two conductor segments 31 accommodated in the slots 31 are joined to each other on a first axial end side of the stator core 30. That is, the stator winding 40 is a segment-type stator winding in which U-shaped conductor segments are electrically connected one another by welding in a predetermined wiring pattern.

The stator core 30 is formed by laminating a plurality of magnetic steel sheets having a ring shape in the axial direction of the stator core 30. The stator core 30 is constituted of a back core section 33 having a ring shape, and a plurality of teeth 34 evenly spaced along the circumferential direction and radially projecting from the back core section 33. The slots 31 are formed between respective adjacent teeth 34. Two slots 31 are formed for each phase of the stator winding 40 for the eight-pole rotor 14 having eight magnetic poles. Accordingly, the number of the slots 31 is 48 (=8×3×2) in this embodiment.

Each of the conductor segments 31 includes a pair of in-slot portions each accommodated in the slot 31, and first and second coil end portions each projecting outward from the slot and extending in the circumferential direction. The stator winding 40 is wound on the slots 31 of the stator core 30 by welding the ends of the first coil end portions of the respective corresponding conductor segments 50 to each other. As shown in FIG. 7, the U-shaped conductor segment 50 is constituted of a pair of straight portions 51 and a turn portion 52 connecting ends of the straight portions 51 to each other. The conductor segment 50 is formed by bending a rectangular conductor coated with an insulating film 57 (see FIG. 6) into a U-shape. The conductor segment 50 is formed with conductor exposed portions 58 at both ends of the straight portions thereof by stripping off the insulating film 57.

The turn portion 52 includes, at its center, a vertex step portion 53 extending along the end surface 30 of the stator core 30. At both ends of the vertex step portion 53, there are formed inclined portions 54 inclined with respect to the end surface 30a of the stator core 30 by a predetermined angle. FIG. 7 shows a pair of the conductor segments 51A and 51B which are inserted into the adjacent slots 31A and 31B of the same phase, respectively.

The reference numeral 24 designates an insulator for insulation between the conductor segment 50A or 50B and the inner wall of the slot 31A or 31B.

The straight portions 51 of each U-shaped conductor segment 50 are inserted into two of the slots 31 from the first axial end side, the two slots 31 being apart from each other by one magnetic pole pitch of the stator core 30. In this way, the straight portions 51 of all the conductor segments 50 are inserted into the whole of the slots 31. In this embodiment, ten straight portions 51 are stacked in a row (ten layers) in the radial direction within each slot 31.

Thereafter, the open end portions (the coil end portions) of a pair of the straight portions 51 projecting from the slot 31 in the second axial end side are bent so as to be skewed with respect to the end surface 30a of the stator core 30 by a predetermined angle, and moved away from each other in the circumferentially opposite directions, to thereby form skew portions 55 having a length nearly equal to half the magnetic pole pitch. When the skew portion 55 is formed in this way, the distal end portion of the skew portion 55, which includes the conductor exposed portion 58, is bent so as to extend in the axial direction of the stator core 30.

As a result, the distal end portions of five skew portions 55 extending in the clockwise direction from one slot 31, and the distal end portions of five skew portions 55 extending in the counter-clockwise direction from the slot 31 apart from this one slot 31 are disposed in a row so as to alternate in the radial direction. That is, the distal end portions of ten skew portions 55 projecting from either one of two slots apart from each other by one magnetic pole pitch and extending in either one of the circumferentially opposite directions so as to approach one another are disposed in a row in the radial direction. In this embodiment, the distal end portions of the skew portions 55 extending in the clockwise direction are disposed in odd-numbered positions starting from the inner side of the slot 31, and the distal end portions of the skew portions 55 extending in the counter-clockwise direction are disposed in even-numbered positions starting from the inner side of the slot 31. The five skew portions 55 extending in the clockwise direction and the five skew portions 55 extending in the counter-clockwise direction intersect one another.

Respective corresponding two of the conductor exposed portions 58 of the distal end portions disposed in a row in the radial direction are joined with each other by arc welding or the like. As a result, a plurality of joint portions 56 in each of which the conductor exposed portions 58 of the corresponding distal end portions are joined to each other are formed on the second axial end side. The joint portions 56 are disposed at a nearly constant pitch in multiple circular rings having nearly the same height in the axial direction. In this embodiment, five sets of forty eight joint portions 56 located along the circumference direction are arranged in a five-fold ring where each five joint portions 56 are disposed in a row in the radial direction.

By connecting the distal end portions (conductor exposed portions 58) of the respective corresponding two skew portions 55 to each other in this way, the conductor segments 50 can be series-connected in a desired wiring pattern. By series-connecting the conductor segments 50 in the desired wiring pattern, the stator winding 40 having the three phase windings (U-, V- and W-phase windings) wound circumferentially spirally along slots 31 of the stator core 30 is formed.

Thereafter, as shown in FIGS. 2 to 6, the ends of the conductor segments 58 are covered by an insulating resin member 60 such that only the conductor exposed portions 58 are completely surrounded by the insulating resin member 60. More specifically, the insulating resin member 60 is formed so as to cover the whole area of the conductor exposed portions 58 in the ends of the conductor segments 50, and the edge portions of the insulating films 57 adjoining the conductor exposed portions 58. Accordingly, the insulating resin member 60 is not formed in the area where the skew portions 55 of the second coil end group 48 intersect with one another (the coil-concentrated area where a large amount of heat is generated).

The insulating resin member 60 is formed so as to bridge together the five joint portions 56 disposed in a row in the radial direction. Meanwhile, a gap S is provided between the insulating resin members 60 covering the joint portions 56 adjacent in the circumferential direction. Accordingly, the liquid coolant supplied to the side of the joint portions 56 of the stator winding 40 can flow smoothly in the radial direction on the surfaces of the insulating resin members 60 passing through the gap S. The insulating resin member 60 bridging together the five joint portions 56 disposed in a row in the radial direction has curved surfaces at its corners where the inner side surface thereof cross both the circumferential side surfaces thereof. This also facilitates the supplied liquid coolant to flow on the surface of the insulating resin member 60 in the radial direction.

As shown in FIGS. 3 and 4, the insulating resin member 60 bridging the joint portions 56 together in the radial direction is uneven at both the circumferential side surfaces and the axial end surface. In this embodiment, a recess is formed between each adjacent two of the joint portions 56 disposed in a row in the radial direction. This makes it possible to increase the surface area of the insulating resin member 60 contacting the liquid resin, to thereby increase the cooling efficiency at the joint portions 56. The insulating resin member 60 is formed by dipping the conductor segments 50 into a liquid resin material selected from epoxy, polyester, urethane and silicone.

In this embodiment, for each phase of the stator winding 40, a winding (coil) which is wound ten-fold around the stator core 30 is formed by the basic U-shaped segments 50. However, the conductor segment integrally including an output lead and a neutral lead, and the conductor segment including the turn portion for connection between the first fold and the second fold are formed by a deformed segment different from the basic conductor segment 50. The winding ends of the respective phases of the stator winding 40 are star-connected using these deformed segments.

As shown in FIGS. 2 and 5, on the first axial end side, the stator winding 40 is formed with a first coil end group 47 constituted of the turn portions 52 of the conductor segments 50 projecting from one end surface of the stator core 30 and stacked in the radial direction of the stator core 30. On the other hand, on the second axial end side, the stator winding 40 is formed a second coil end group 48 constituted of the skew portions 55 and joint portions 56 projecting from the other end surface of the stator core 30 and stacked in the radial direction of the stator core 30.

In this embodiment, the thickness in the axial direction of the rotor 14 is thicker than that of the stator core 30, and the axial ends of the rotor 14 are located at the positions opposite to the first and second coil end groups 47 and 48, respectively. Accordingly, the liquid coolant reaching the rotor 14 is efficiently spread toward the first and second coil end groups 47 and 48 when the rotor 14 rotates.

The electric rotating machine 1 described above operates such that when the stator winding 40 of the stator 20 is supplied with a current, the rotor 14 rotates together with the rotating shaft 13 to supply torque to various apparatuses from the rotating shaft 13. At this time, the liquid coolant is discharged from the discharge holes 15a and 16a of the pipelines 15 and 16. The liquid coolant discharged from the discharge holes 15a and 16a is supplied to the first and second coil end groups 47 and 48 of the stator winding 40. The liquid coolant supplied to the first and second coil end groups 47 and 48 flows downward on the surfaces of the first and second coil end groups 47 and 48 to reach the rotor 14. The liquid coolant that has reached the rotating rotor 14 is spread in the radial direction. In this way, the liquid coolant is evenly spread from the rotor 14 over the whole circumferential area of the first and second coil end groups 47 and 48.

The joint portions 56 are bridged together by the insulating resin member 60 only in the radial direction, and the gap S is provided between each adjacent two of the insulating resin members 60 respectively bridging together circumferentially adjacent two of the rows of the joint portions 56. Accordingly, the liquid coolant spread over the second coil end group 48 can flow smoothly in the radial direction on the surfaces of the insulating resin members 60. Hence, the whole area of the second coil end group 48 is reliably and efficiently cooled by the liquid coolant flowing in the radial direction on the surface of the second coil end group 48. Since the insulating resin member 60 is not provided in the coil-concentrated area where the skew portions 55 of the second coil end group 48 intersect one another, the liquid coolant directly contacts the coil-concentrated area and accordingly the second coil end group 48 is further efficiently cooled.

In this embodiment, the stator winding 40 is a three-phase winding, and the voltage difference within this stator winding 40 becomes highest between any two of the three different phases (in the circumferential direction). Accordingly, by providing the gap S between each adjacent two of the insulating resin members bridging together circumferentially adjacent two of the rows of the joint portions 56, high insulating performance can be ensured.

In this embodiment, the joint portions 56, in which the end portions of respective corresponding two of the conductor segments 50 are joined together, are disposed in multiple circular rings. These joint portions 56 are covered and bridged together by the insulating resin member 60 only in the radial direction. Further, the gap S is provided between each adjacent two of the insulating resin members 60 bridging together circumferentially adjacent two of the rows of the joint portions 56. Therefore, according to this embodiment, it is possible to provide a high-voltage and high-output electric rotating machine having high cooling and high insulating performances.

In this embodiment, the insulating resin member 60 bridging together the joint portions 56 in the radial direction is formed so as to be uneven at both the circumferential side surfaces and the axial end surface. Accordingly, it possible to increase the surface area of the insulating resin member 60 contacting the liquid resin, to thereby further increase the cooling efficiency at the joint portions 56.

In this embodiment, the thickness in the axial direction of the rotor 14 is thicker than that of the stator core 30, and the axial ends of the rotor 14 are located at the positions opposite to the first and second coil end groups 47 and 48, respectively. Accordingly, the liquid coolant reaching the rotor 14 is efficiently spread toward the first and second coil end groups 47 and 48 when the rotor 14 rotates.

### Other Embodiments

It is a matter of course that various modifications can be made to the above described embodiment as described below.

In the above embodiment, the insulating resin member 60 bridging the joint portions 56 together in the radial direction is formed to be uneven at both the circumferential side surfaces and the axial end surface. However, it may be formed to be uneven only at one of the circumferential side surfaces and the axial end surface. Further, in view of easiness of forming the insulating resin member, neither the circumferential side surfaces nor the axial end surface may be uneven. However, in this case, since the surface area of the insulating resin member 60 is not increased, it cannot be expected to increase the cooling efficiency at the joint portions 56.

In the above embodiment, liquid resin is used as the material of the insulating resin member 60. However, powder resin may be used as the material of the insulating resin member 60. In this case, powder resin is adhered to the surfaces of predetermined portions of the conductor segments 50, and then hardened to form the insulating resin member 60.

The embodiment described above is directed to an electric motor. However, it should be noted that the present invention is applicable to an electric rotating machine mounted on a vehicle to be used as an alternator, an electric motor, or an electric rotating machine capable of operating both an alternator and an electric motor.

The above explained preferred embodiments are exemplary of the invention of the present application which is described solely by the claims appended below. It should be understood that modifications of the preferred embodiments may be made as would occur to one of skill in the art.

What is claimed is:

1. An electric rotating machine comprising:
a rotor;
a stator including a stator core disposed facing the rotor and a stator winding wound around the stator core; and
a cooling means for supplying liquid coolant to the stator winding to cool the stator winding,
wherein
the stator winding includes a plurality of conductor segments each having a first in-slot portion accommodated in a first one of slots formed in the stator core and a second in-slot portion accommodated in a second one of the slots, and first and second coil end portions respectively projecting from the first and second ones of the slots in an axial direction of the stator core and extending in a circumferential direction of the stator core,
the first coil end portion includes a turn portion connecting the first and second in-slot portions on a first axial end side of the stator core,
the second coil end portion includes a skew portion intersecting with a skew portion of another one of the conductor segments on a second axial end side of the stator core,
a plurality of joint portions where distal end portions of respective corresponding two of the skew portions are joined to each other are formed on the second axial end side of the stator core, the joint portions have a substantially same axial height and being disposed at a substantially constant pitch and in multiple circular rings,
the joint portions are disposed in a plurality of rows in the axial direction, each row of the joint portions being covered and bridged together by an insulating resin member, and
a gap is provided between each circumferentially adjacent two of the rows of the joint portions.

2. The electric rotating machine according to claim 1, wherein each of the insulating resin members covering the rows of the joint portions is formed so as to be uneven in at least one of circumferentially side surfaces and an axial end surface thereof.

3. The electric rotating machine according to claim 1, wherein a thickness in the axial direction of the stator core is thicker than a thickness in the axial direction of the rotor, and axial ends of the rotor are respectively located at positions axially opposite to the first and second coil end portions of the stator winding, respectively.
